(19) United States
(12) Patent Application Publication
(10) Pub. No.: US 2006/0044754 A1
(43) Pub. Date: Mar. 2, 2006

(54) External power structure for industrial thin-type computer

(76) Inventor: Kuo-Chuan Hung, Lu-Chou City (TW)

Correspondence Address: Kuo-Chuan Hung, P.O. Box No. 6-57, Junghe, Taipei, 235, TW

(21) Appl. No.: 10/928,095

(22) Filed: Aug. 30, 2004

(51) Int. Cl. G06F 1/20

(52) U.S. Cl. 361/687; 361/727

(57) ABSTRACT

An external power structure for an industrial thin-type computer comprises primarily a current transformation circuit and a transformer. The current transformation circuit is located at an adequate position inside a computer casing, with a power hole at the rear part to connect with the transformer, thereby serving as the power source of the industrial thin-type computer. The transformer, which generates more heat in the power supply, is separated with the current transformation circuit, which generates less heat. After connecting the current transformation circuit with a motherboard, the current transformation circuit is connected with the transformer by another cord, thereby avoiding the continuous heat generation inside the industrial thin-type computer.

### BACKGROUND OF THE INVENTION

a) Field of the Invention

The present invention relates to an external power structure for an industrial thin-type computer, and more particularly to a power structure comprising a current transformation circuit and a transformer with the current transformation circuit installed at an adequate position inside a casing of an industrial thin-type computer and connected with a power hole located at a rear part of the current transformation circuit and passing through the computer casing to connect with the transformer, thereby serving as the power source of the industrial thin-type computer.

b) Description of the Prior Art

As a CPU of an industrial thin-type computer usually consumes higher power, the CPU also generates the most heat. In addition, other heat source also exists in a computer casing, such as a power supply, that generates less heat than a CPU does. However, insufficient heat dissipation and even the reduction of life for components of a power supply will be induced due to the fact that these heat sources will automatically generate heat and occupy the built-in heat dissipating space in the computer casing.

Referring to FIG. 1, a conventional power supply a comprising a transformer a2, a current transformation circuit a3, and a fan a4 installed in a box a1, is installed at an adequate position in a computer casing b. As the inner space of an industrial thin-type computer is more compact than that of a general desktop computer, the efficiency of heat dissipation is also inferior. The heat dissipation of a CPU and casing will be the major concern of the general desktop computer. Nevertheless, due to the compactness of inner space of an industrial thin-type computer, and the loose separation of heat source, it is difficult to achieve the function of heat dissipation in large area only with fans. Therefore, heat will continuously increase and cannot be expelled immediately, thereby accumulating excessive heat and inducing computer crash by overheat.

Accordingly, the present invention separates the transformer, which generates more heat, with the current transformation circuit, which generates less heat, connects the current transformation circuit with a motherboard, and connects with the transformer by another cord, thereby avoiding the continuous heat generation inside an industrial thin-type computer, and increasing the efficiency of heat dissipation devices inside a computer casing.

### SUMMARY OF THE INVENTION

The primary object of the present invention is to provide an external power to avoid the continuous heat generation inside an industrial thin-type computer, to increase the space of air flow inside a computer casing, and to increase the air flow inside the computer casing, thereby achieving the high performance of heat dissipation by lowering temperature.

Accordingly, the present invention comprises primarily a current transformation circuit and a transformer wherein the current transformation circuit is installed at an adequate position inside an industrial thin-type computer with a power hole located at the rear part of the computer casing, then the current transformation circuit is connected with a motherboard by a connecting socket, and connected with the transformer by another cord.

Accordingly, due to the fact that the transformer, which generates more heat in a power supply, is separated with the current transformation circuit, which generates less heat, the current transformation circuit is located at an adequate position inside the computer casing, and is connected with the external transformer outside of the computer casing by another cord, the heat generated inside the industrial thin-type computer can be reduced effectively, and the space occupied by the conventional power supply can also be reduced, thereby greatly increasing the air flow inside the computer casing, and achieving the high performance of heat dissipation by lowering temperature.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional power supply.

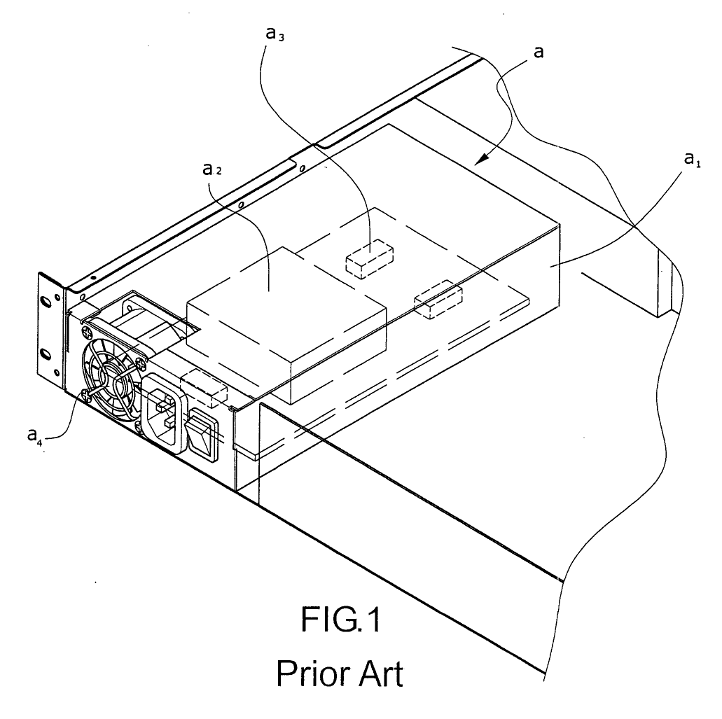

FIG. 2 shows a schematic view of the present invention.

FIG. 3 shows structure of a current transformation circuit of the present invention.

FIG. 4 shows a schematic exploded view of the implementation for the present invention.

### DETAILED DESCRIPTION OF THE PREFERRED EMBODIMENTS

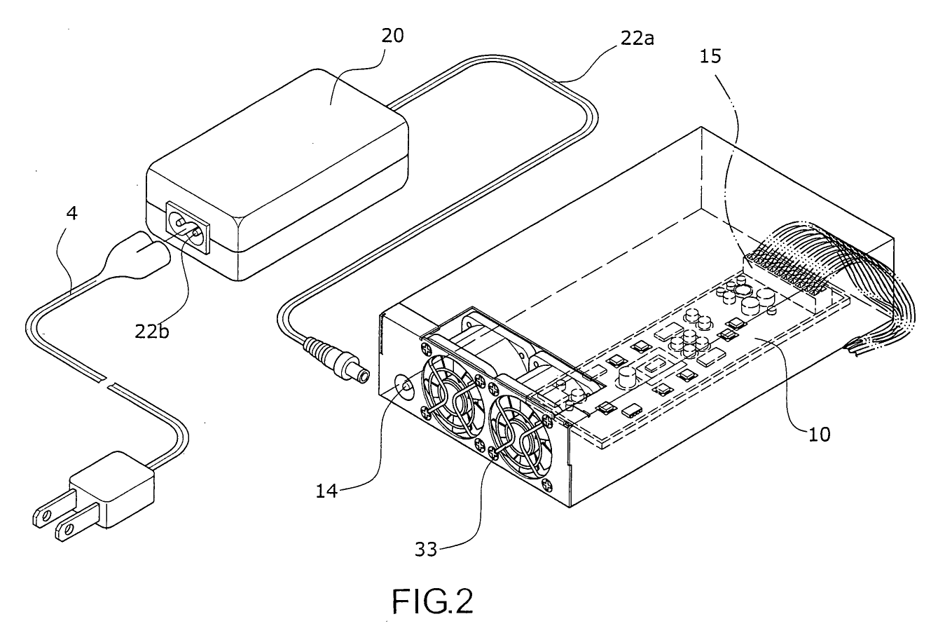

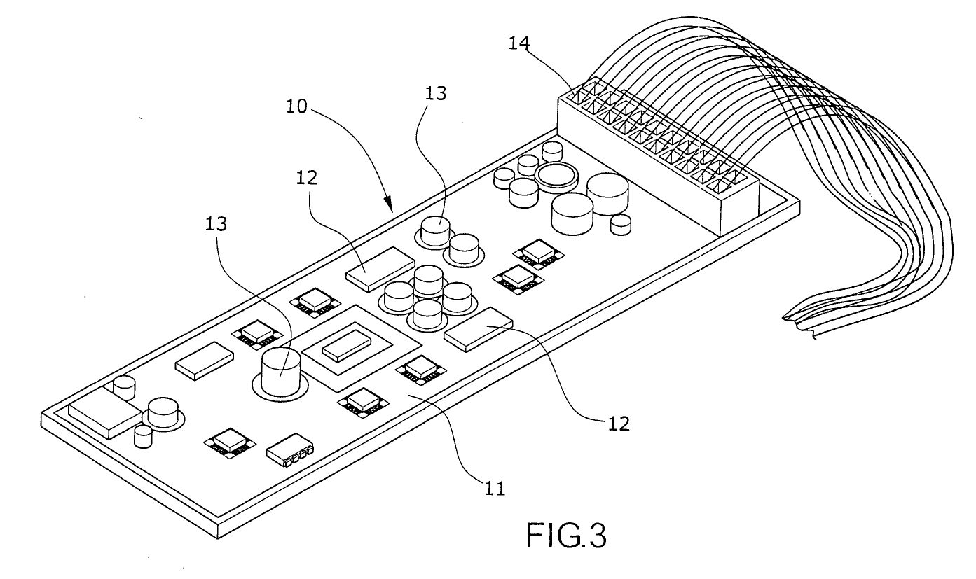

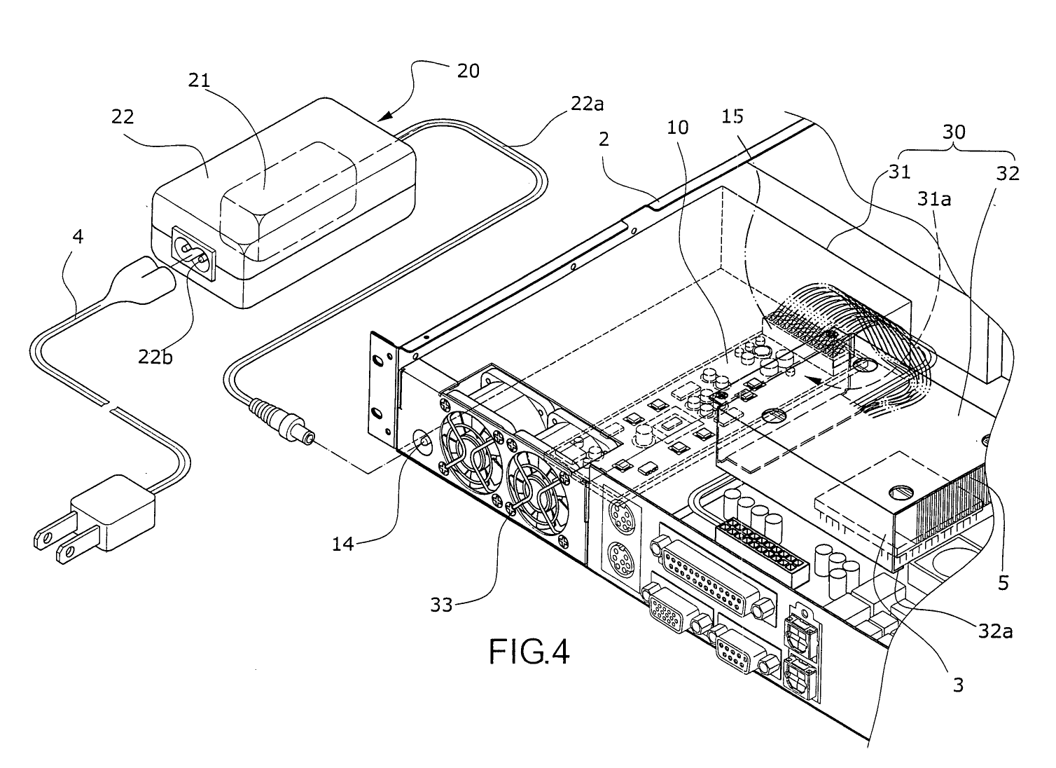

Referring to FIG. 2, FIG. 3, and FIG. 4, the present invention comprises primarily a current transformation circuit 10, and a transformer 20, wherein the current transformation circuit 10 consists of a circuit board 11, installed with a plurality of chips 12, capacitors 13, a power hole 14, and a motherboard connecting socket 15. The current transformation circuit 10 is installed at an adequate position inside an industrial thin-type computer casing 2, with the power hole 14 passing through the rear part of the computer casing 2, and is connected the motherboard 3 by the connecting socket 15. The transformer 20 consists of a voltage transformation circuit 21 inside a box 22, with a connecting cord 22a at the front of the box 22 to connect with the power hole 14 of the current transformation circuit 10, and a power socket 22b at a rear part thereof to connect with the power cord 4.

Referring to FIG. 4, which shows a schematic exploded view of the implementation for the present invention, a wind shade 30 is used to cover a current transformation circuit 10 after installing the current transformation circuit 10 at an adequate position inside a computer casing 2. The wind shade 30 consists of a shade body 31 and a tube body 32, with a first opening 31a at one side of the shade body 31. The size of the opening 31a fits with a second opening of the tube body 32. The tube body 32 is U-shape and its size fits with fins 5. Bend pieces 32a are formed by bending inward at a lower edge of two sides of the tube body 32, in order to completely cover the fins 5 in the tube body 32, and constitutes a wind tunnel. A plurality of fans 33 is located at a back panel of the computer casing 2. The current transformation circuit 10 is connected with the motherboard 3, and then connected with the transformer 20 outside of the computer casing 2 by a connecting cord 22a.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An external power structure for an industrial thin-type computer comprising a current transformation circuit and a transformer to effectively reduce heat generated inside the industrial thin-type computer and greatly increase air flow inside a computer casing, thereby achieving high performance of heat dissipation by lowering temperature; the current transformation circuit further comprising a circuit board installed with a plurality of chips, capacitors, a power hole, and a motherboard connecting socket; the power hole passing through a rear part of the computer casing, and the current transformation circuit connecting with the motherboard by a motherboard connecting socket, following the installation of the current transformation circuit at an adequate position inside the industrial thin-type computer casing; the transformer further comprising a voltage transformation circuit inside a box, with a connecting cord at a front part of the box to connect with the power hole of the current transformation circuit, and a power socket at a rear part of the box to connect with a power cord;

2. The external power structure for an industrial thin-type computer according to claim 1, wherein, the current transformation circuit being covered inside a wind shade;

3. The external power structure for an industrial thin-type computer according to claim 1, wherein, the wind shade further comprising a shade body and a tube body; the shade body having a first opening formed at one side thereof corresponding to a second opening formed on an end of the tube body in size; the tube body is U-shape having a size fitting with fins, and having bend pieces at a lower edge of two sides to completely hold the fins inside the tube body, and thus forming a wind tunnel, and with a plurality of fans disposed at the back panel of the computer casing.
